(19) United States
(12) Patent Application Publication
(10) Pub. No.: US 2025/0252351 A1
(43) Pub. Date: Aug. 7, 2025

(54) ARTIFICAL INTELLIGENCE TRAINING METHOD FOR IDENTIFYING INCORRECT TRAINING DATA AND ARTIFICAL INTELLIGENCE CORRECTING METHOD USING THE SAME

(71) Applicant: Charles Lap San CHAN, Taipei (TW)

(72) Inventor: Charles Lap San CHAN, Taipei (TW)

(21) Appl. No.: 19/024,150

(22) Filed: Jan. 16, 2025

(30) Foreign Application Priority Data
Feb. 2, 2024 (TW) 113104260

(51) Int. Cl. G06N 20/00

(52) U.S. Cl. CPC G06N 20/00

(57) ABSTRACT

The disclosure describes an artificial intelligence training method for identifying incorrect training data and an artificial intelligence correcting method using the same. When training an artificial intelligence (AI) model, a plurality of training data along with their corresponding tag data and coded data are input, thereby ensuring that the training process of the AI model remains unaffected. When the AI model is used to obtain an incorrect answer, the tag data are obtained based on the coded data. A piece of training data referenced by the incorrect answer is identified using the tag data, thereby efficiently updating the original incorrect training data.

### BACKGROUND OF THE INVENTION

This application claims priority for the TW patent application Ser. No. 11/310,4260 filed on 2 Feb. 2024, the content of which is incorporated by reference in its entirely.

### FIELD OF THE INVENTION

The present invention relates to an artificial intelligence training method for identifying incorrect training data and an artificial intelligence correcting method using the same, particularly to an artificial intelligence training method and an artificial intelligence correcting method using the same, which add tag data and coded data to corresponding training data for training an artificial intelligence (AI) model without affecting the training process of the AI model. Then, the methods can rapidly identify the incorrect training data and update them.

### DESCRIPTION OF THE RELATED ART

In the current field of artificial intelligence (AI), training AI models is a key step whose purpose is to enable the model to learn and make accurate predictions or decisions based on the provided data. In practice, however, this process faces many challenges and difficulties. One of the biggest problems is that it is difficult to determine which one of inputs or specific inputs caused an incorrect answer when an AI model gives the incorrect answer. The problem not only affects the accuracy and reliability of the model, but also limits the application potential of the model in various industries.

In the training process of the traditional AI model, the model is usually trained to identify the correlation between input data and output results. However, the inner working mechanism of this process is unknown to developers. When the model generates incorrect or unexpected results, finding the source of the problem becomes a difficult task. Especially in large-scale data sets, the impact of each piece of data may be hidden in the vast amount of information.

Therefore, it is extremely important to develop a method that can reversely track and determine the specific training data that caused the model to generate incorrect data. This not only helps improve the accuracy and reliability of the model, but also has great significance for understanding the decision-making process of the model, improving the interpretability of the model and its credibility in practical applications.

In general, developing an AI model training method that can reversely track and determine the specific training data that caused the model to generate incorrect data is not only a technical challenge, but also an important step in promoting the wider application of AI technology. By improving the interpretability and reliability of models, one can further expand the application of AI in various industries and ultimately achieve smarter and more reliable technical solutions.

### SUMMARY OF THE INVENTION

The primary objective of the present invention is to provide an artificial intelligence training method for identifying incorrect training data, which can add corresponding tag data and coded data to training data for training an artificial intelligence (AI) model, thereby ensuring that the training process of the AI model remains unaffected.

Another objective of the present invention is to provide an artificial intelligence correcting method for identifying incorrect training data, which can obtain the tag data based on the coded data when using the AI model to obtain an incorrect answer. A piece of training data referenced by the incorrect answer is identified using the tag data, thereby efficiently updating the original incorrect training data.

In order to achieve the foregoing objectives, the present invention provides an artificial intelligence training method for identifying incorrect training data. The method includes:
Step (A): obtaining a plurality of training data and a plurality of tag data corresponding thereto;
Step (B): performing a coding process to convert the plurality of tag data into a plurality of coded data;
Step (C): inputting training data that include the plurality of training data and the plurality of coded data corresponding thereto to an original artificial intelligence (AI) model to obtain a trained artificial intelligence (AI) model; and
Step (D): testing the trained AI model to determine whether the trained AI model provides a correct answer and a piece of coded data, wherein the piece of coded data corresponds to a piece of training data referenced by the correct answer.

The present invention also provides an artificial intelligence correcting method for identifying incorrect training data, which includes:
Step (A): querying a trained artificial intelligence (AI) model to obtain an incorrect answer and a piece of coded data, wherein the piece of coded data corresponds to a piece of training data referenced by the incorrect answer;
Step (B): correcting the piece of training data into a piece of updated training data that corresponds to the piece of coded data;
Step (C): inputting training data that include the piece of updated training data and the piece of coded data to the AI model to obtain an updated artificial intelligence (AI) model; and
Step (D): testing the updated AI model to determine whether the updated AI model passes an enhanced scoring process.

The features, advantages, or similar expressions mentioned in the specification do not mean that all the features and advantages that can be realized by the present invention should be in any single specific embodiment of the present invention. Rather, it should be understood that the expression of related features and advantages means that the specific features, advantages, or characteristics described in conjunction with specific embodiments are included in at least one specific embodiment of the present invention. Therefore, the discussion of features and advantages, and similar expressions in the specification is related to the same specific embodiment, but it is not necessary.

Below, the embodiments are described in detail in cooperation with the drawings to make easily understood the technical contents, characteristics and accomplishments of the present invention.

### BRIEF DESCRIPTION OF THE DRAWINGS

FIG. 1 is a flowchart of an artificial intelligence training method for identifying incorrect training data according to a preferred embodiment of the present invention;

FIG. 2 is a flowchart of an artificial intelligence correcting method for identifying incorrect training data according to a preferred embodiment of the present invention; and

FIG. 3 is a block diagram illustrating an exemplary computer system/server suitable for implementing embodiments of the present invention.

### DETAILED DESCRIPTION OF THE INVENTION

In order to make the description of the present disclosure more detailed and complete, the following provides an illustrative description for the implementation aspects and specific embodiments of the present invention; but this is not the only way to implement or use specific embodiments of the present invention. The implementations cover the characteristics of specific embodiments and the steps and sequences of the method used to construct and operate these specific embodiments. However, other specific embodiments can also be used to achieve the same or equal functions and sequence of steps.

It should be noted that, unless otherwise specified, all functions described herein may be implemented in hardware or used as software instructions that enable a computer to perform predetermined operations, wherein the software instructions are implemented in a computer-readable storage media, such as a random-access memory (RAM), a hard disk drive, a flash memory, or other types of a computer-readable storage media known to those skilled in the art. In some embodiments, the predetermined operations of the computer are performed by a processor, such as a computer, or performed by program codes such as computer program codes or program codes of software or firmware. In some embodiments, the predetermined operations of the computer are performed by integrated circuits encoded to perform these functions. Furthermore, it should be understood that various operations described herein as being performed by a user may be performed manually by the user or may be automatically performed with or without instructions provided by the user.

In order to make the purpose, technical solutions and advantages of the embodiments of the present invention clearer, the technical solutions in the embodiments of the present invention will be clearly and completely described below in conjunction with the accompanying drawings in the embodiments of the present invention. Obviously, the described embodiments are parts of the embodiments of the present invention rather than all the embodiments. Based on the embodiments of the present invention, all other embodiments obtained by those of ordinary skill in the art without creative efforts are included within the scope of the present invention.

It should be noted that the terminals involved in the embodiments of the present invention may include, but are not limited to, mobile phones, personal digital assistants (PDAs), wireless handheld devices, wireless network devices, personal computers, portable computers, tablets computers, MP3 players, MP4 players, wearable devices (such as smart glasses, smart watches, smart bracelets, etc.), mobile phones, smart phones, landline smart phones, etc.

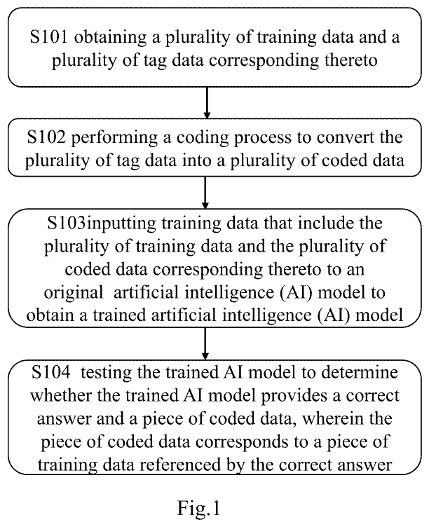

FIG. 1 is a flowchart of an artificial intelligence training method for identifying incorrect training data according to a preferred embodiment of the present invention. As illustrated in FIG. 1, the method includes the following steps.

In Step 101, a plurality of training data and a plurality of tag data corresponding thereto are obtained.

In Step 102, a coding process is performed to convert the plurality of tag data into a plurality of coded data.

In Step 103, training data that include the plurality of training data and the plurality of coded data corresponding thereto are input to an original artificial intelligence (AI) model to obtain a trained artificial intelligence (AI) model.

In Step 104, the trained AI model is tested to determine whether the trained AI model provides a correct answer and a piece of coded data, wherein the piece of coded data corresponds to a piece of training data referenced by the correct answer.

It should be noted that the body that performs Steps 101˜104 can be an application installed in the local terminal, either a plug-in program or a functional unit such as software development kit (SDK) in the application installed in the local terminal, or a processing engine in a network-side server, the embodiment is not limited thereto.

It can be understood that the application can be an application program (e.g., a native App) installed in the terminal or a webpage program (e.g., a web App) of the browser on the terminal, the embodiment is not limited thereto.

In Step 101, a plurality of training data and a plurality of tag data corresponding thereto are obtained. The plurality of training data can be, for example, descriptive data. For example, the mortgage interest rate of OO Bank in 2024 is 2.1%. Alternatively, each of the plurality of training data includes a piece of question data and a piece of answer data. For example, a piece of question data states, “What is the mortgage interest rate of OO Bank in 2024? A piece of answer data states 2.1%. It should be understood that the training data of the present invention are not limited to the foregoing formats.

In addition, each piece of training data corresponds to a piece of existing tag data. The piece of tag data is used to tag the person or institution that checked the content or correctness of the piece of training data and used as a unique number for tagging the piece of training data. For example, the foregoing training data state, “OO Bank's mortgage interest rate in 2024 is 2.1%”, the corresponding tag data state, “data set manager ID_1, AI assistant ID_M5, data set ID_100”, where 1 represents the number of the data set manager, M5 represents the number of an AI assistant, and 100 represents the unique number of the piece of training data, but it should be understood that the tag data of the present invention are not limited to the foregoing format.

In Step 102, a coding process is performed to convert the plurality of tag data into a plurality of coded data. In an embodiment of the present invention, the coding process is used to convert the plurality of tag data into a plurality of coded data that cannot be understood by the original AI model. Alternatively, the coding process converts the plurality of tag data into a plurality of coded data composed of English letters, numbers, and symbols. The coding process may be a Base64 coding process, but the present invention is not limited thereto. In this step, the coding process is used to convert the plurality of tag data into a plurality of coded data that cannot be understood by the original AI model to avoid affecting the training process of the AI model.

For example, one of the plurality of tag data states, “data set manager ID_1, AI assistant ID M5, data set ID_100”. After the Base64 encoding process, the piece of tag data can be converted into a piece of coded data. For example, the piece of coded data states, “6LOH5paZ6ZuG566h55CG6ICFICBJRF8x77yMQUkgYXNzaXN0YW50IElEX00177yMI Oizh+aWmembhklEXzEwMA==”. Since the AI model cannot understand the meaning of the coded data, the coded data can avoid affecting the training process of the AI model.

In Step 103, training data that include the plurality of training data and the plurality of coded data corresponding thereto are input to an original artificial intelligence (AI) model to obtain a trained artificial intelligence (AI) model.

In Step 104, the trained AI model is tested to determine whether the trained AI model provides a correct answer and a piece of coded data, wherein the piece of coded data corresponds to a piece of training data referenced by the correct answer. For example, if someone asks the trained AI model the question “What will be the mortgage interest rate of OO Bank starting from 2024?”, the trained AI model should answer “2.1%”. The trained AI model will provide the coded data as retention data. When it is necessary to query the training data referenced by the incorrect answer, the tag data can be reversely queried based on the coded data, and the corresponding training data can be identified based on the tag data (the details will be discussed later).

According to the foregoing description, the present invention provides an artificial intelligence training method for identifying incorrect training data. When training the AI model, the method adds a plurality of training data along with their corresponding tag data and coded data, thereby ensuring that the training process of the AI model remains unaffected.

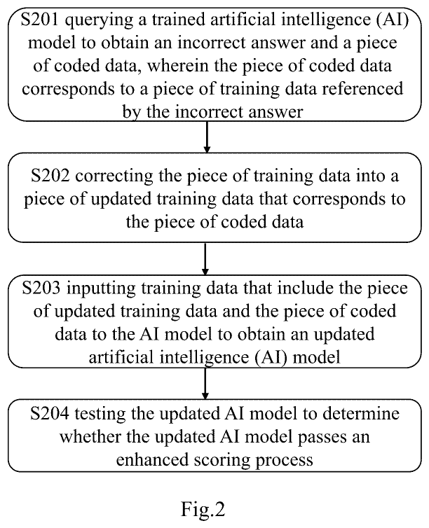

FIG. 2 is a flowchart of an artificial intelligence correcting method for identifying incorrect training data according to a preferred embodiment of the present invention. As illustrated in FIG. 2, the method includes the following steps.

In Step 201, a trained artificial intelligence (AI) model is queried to obtain an incorrect answer and a piece of coded data, wherein the piece of coded data corresponds to a piece of training data referenced by the incorrect answer.

In Step 202, the piece of training data is corrected into a piece of updated training data that corresponds to the piece of coded data.

In Step 203, training data that include the piece of updated training data and the piece of coded data are input to the AI model to obtain an updated artificial intelligence (AI) model.

In Step 204, the updated AI model is tested to determine whether the updated AI model passes an enhanced scoring process.

In Step 201, the reason why an incorrect answer is obtained when querying a trained AI model may include two situations. One situation is that the initial training data are incorrect. Another situation is that the original correct answer becomes an incorrect answer due to specific reasons. For example, on Jan. 1, 2024, OO Bank's mortgage interest rate in 2024 was 2.1%. However, starting from Jul. 1, 2024, OO Bank's mortgage interest rate has been changed to 3.2%. The AI model has not been updated to have the message. In other words, when the user asks the trained AI model after Jul. 1, 2024, “What is the mortgage interest rate of OO Bank in 2024?”, the AI model will respond, “OO Bank's mortgage interest rate in 2024 is 2.1%” as the answer.

In addition, as mentioned above, the trained AI model of the present invention will not only respond an answer, but also provide coding data corresponding to the answer, such as the coding data “6LOH5paZ6ZuG566h55CG6ICFICBJRF8x77yMQUkgYXNzaXN0YW50IE1EX00177yMI Oizh+aWmembhklEXzEwMA==” mentioned above. Using the coded data as the input value, a decoding process can be performed to obtain tag data. Then, the corresponding training data can be queried based on the tag data. For example, in one embodiment of the present invention, after the Base64 decoding process, the coded data can be converted into the tag data, namely “data set manager ID_1, AI assistant ID_M5, data set ID_100”. Finally, the corresponding training data are queried and obtained based on the coding data, namely the training data “OO Bank's mortgage interest rate in 2024 is 2.1%” referenced by the incorrect answer.

In Step 202, the piece of training data is corrected into a piece of updated training data that corresponds to the piece of coded data. In the embodiment, the updated training data state, “OO Bank's mortgage interest rate in 2024 is 3.2%”. This updated training data are just correction data and thus their original tag data and coded data are still used.

In Step 203, training data that include the piece of updated training data and the piece of coded data are input to the AI model to obtain an updated artificial intelligence (AI) model.

In Step 204, the updated AI model is tested to determine whether the updated AI model passes an enhanced scoring process. In the enhanced scoring process, a plurality of questions are provided to test the updated AI model. The plurality of questions are associated with the piece of training data referenced by the incorrect data. Alternatively, in the enhanced scoring process, a plurality of keywords are provided based on the piece of training data referenced by the incorrect answer. The plurality of keywords are configured to design the plurality of questions associated with the incorrect answer. In addition to the original incorrect training data, the enhanced scoring process can comprehensively evaluate whether there are currently unknown incorrect training data. If found, the incorrect training data can be updated to become the correct training data.

For example, when the foregoing original training data state, “OO Bank's mortgage interest rate in 2024 is 2.1%”, the questions can be designed for different years in the enhanced scoring process, such as “What is OO Bank's mortgage interest rate in 2023?” and “What is the mortgage interest rate of OO Bank in 2022?”. In addition, the questions can be designed for different banks, such as “What is the mortgage interest rate of XX Bank in 2024?” and “What is the mortgage interest rate of YY Bank in 2024?”. The questions can be designed for different mortgage products, such as “What is the youth mortgage interest rate of OO Bank in 2024?”, “What is the index mortgage interest rate of OO Bank in 2024?” and so on.

According to the foregoing description, the present invention provides an artificial intelligence correcting method for identifying incorrect training data. When the AI model is used to identify an incorrect answer, the tag data can be obtained based on the coding data. Then, the tag data can be used to identify a piece of training data referenced by the incorrect answer, thereby efficiently updating the original incorrect training data. In addition to the original incorrect training data, the enhanced scoring process can comprehensively evaluate whether there are currently unknown incorrect training data, so as to update the possible incorrect training data in the original AI model at a time.

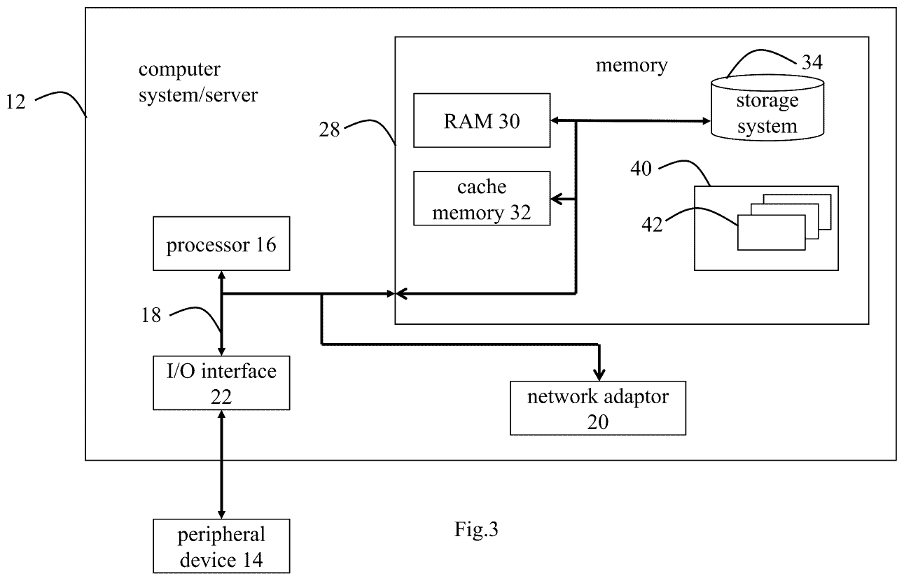

FIG. 3 is a block diagram illustrating an exemplary computer system/server suitable for implementing embodiments of the present invention. FIG. 3 shows an exemplary computer system/server 12 that should not impose any limitations on the functions and the application ranges of the embodiments of the present invention.

As illustrated in FIG. 3, the computer system/server 12 is implemented in the form of a general computing device. The components of the computer system/server 12 may include, but are not limited to, one or more processors (processing units) 16, a memory 28, and a bus 18 connected to various system components (including the memory 28 and the processor 16).

Bus 18 represents one or more of any of several kinds of bus structures, including a memory bus or a memory controller, a periphery bus, an accelerated graphics port, and a processor or a local area bus using any bus structure among a plurality of bus structures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The computer system/server 12 typically includes a variety of computer system readable mediums. These mediums may be any available medium accessible to the computer system/server 12, including volatile and non-volatile mediums, mobile and immobile mediums.

Memory 28 may include a computer system readable medium in the form of volatile memory, e.g., a random-access memory (RAM) 30 and/or a cache memory 32. The computer system/server 12 may further include other mobile/immobile, volatile/non-volatile computer system storage mediums. For example, storage system 34 may be used to read and write immobile and non-volatile magnetic media. Although not shown in FIG. 2, a disk driver that may read/write the mobile non-volatile disk (e.g., “floppy disk”), and an optical disk driver that reads/writes the mobile non-volatile optical disk (e.g., CD-ROM, DVD-ROM, or other optical medium). In these cases, each driver may be connected to the bus 18 through one or more data medium interfaces. The memory 28 may include at least one program product, which program product has a set (e.g., at least one) of program modules. These program modules are configured to perform the functions of various embodiments of the present invention.

Program/utility tool 40 having a set (at least one) of the program module 42 may be stored in, e.g., a memory 28. Such program module 42 includes, but not limited to, an operating system, one or more applications, other program modules, and program data; each or a certain combination of these examples might include implementation of the network environment. The program module 42 generally performs the functions and/or methods in the embodiments described in the present invention.

The computer system/server 12 may also communicate with one or more peripheral devices 14 (e.g., keyboard, pointing device, display, etc.), but also communicate with one or more devices enabling the user to interact with the computer system/server 12, and/or communicate with any device (e.g., network card, modem, etc.) enabling the computer system/server 12 to communicate with one or more other computing devices. This communication may be performed through an input/output (I/O) interface 22. Moreover, the computer system/server 12 may also communicate with one or more networks (e.g., local area network (LAN), wide area network (WAN) and/or public network, e.g., Internet) through a network adaptor 20. As shown in FIG. 2, the network adaptor 20 communicates with other module of the computer system/server 12 via the bus 18. It should be noted that although not shown in the figure, other hardware and/or software module may be used in conjunction with the computer system/server 12, including, but not limited to: microcode, device driver, redundant processing unit, external disk driving array, RAID system, disk driver, and data backup storage system, etc.

Processor 16 runs programs stored in the memory 28 to perform various functional applications and data processing, such as implementing the method in the embodiment shown in FIG. 1.

The present invention also discloses a computer-readable storage medium where a computer program is stored. When the program is run by the processor, the method in the embodiment shown in FIG. 1 will be implemented.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or apparatus, or any suitable combination of the foregoing. More specific examples (a non-exhaustive list) of the computer readable storage medium would include the following: an electrical connection having one or more wires, a portable computer diskette, a hard disk drive, a random access memory (RAM), a read-only memory (ROM), an erasable programmable read-only memory (EPROM or Flash memory), an optical fiber, a portable compact disc read-only memory (CD-ROM), an optical storage apparatus, a magnetic storage apparatus, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In the several embodiments provided in this disclosure, it should be understood that the devices and methods disclosed can be implemented by other means. For example, the device embodiments described above are only schematic. For example, the division of the modules is only by logical function, and can be implemented in another way.

The modules described as separate parts may or may not be physically separate, and the parts displayed as modules may or may not be physical units, that is, may be located in one place, or may be distributed over multiple network units. Part or all of the modules can be selected according to the actual needs to achieve the purpose of this embodiment.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

The foregoing integrated units implemented in the form of software function units may be stored in a computer readable storage medium. The foregoing software function units may be stored in a storage medium, and include several instructions to enable a computing device (which may be a personal computer, server, or network device, etc.) or processor to execute a part of steps of the method described in the embodiment of the present disclosure. The foregoing storage media include USB flash drives, mobile hard drives, read-only memories (ROMs), random access memories (RAMs), magnetic disks, optical disks, or other media that can store program codes.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. An artificial intelligence training method for identifying incorrect training data, comprising:
Step (A): obtaining a plurality of training data and a plurality of tag data corresponding thereto;
Step (B): performing a coding process to convert the plurality of tag data into a plurality of coded data;
Step (C): inputting training data that include the plurality of training data and the plurality of coded data corresponding thereto to an original artificial intelligence (AI) model to obtain a trained artificial intelligence (AI) model; and
Step (D): testing the trained AI model to determine whether the trained AI model provides a correct answer and a piece of coded data, wherein the piece of coded data corresponds to a piece of training data referenced by the correct answer.

2. The artificial intelligence training method for identifying incorrect training data according to claim 1, wherein each of the plurality of training data includes question data and answer data.

3. The artificial intelligence training method for identifying incorrect training data according to claim 1, wherein the coding process is performed to convert the plurality of tag data into the plurality of coded data that are not understood by the original AI model.

4. The artificial intelligence training method for identifying incorrect training data according to claim 3, wherein the coding process is performed to convert the plurality of tag data into the plurality of coded data that are composed of English letters, numbers, and symbols.

5. The artificial intelligence training method for identifying incorrect training data according to claim 1, wherein the coding process is a Base64 coding process.

6. An artificial intelligence correcting method for identifying incorrect training data, comprising:
Step (A): querying a trained artificial intelligence (AI) model to obtain an incorrect answer and a piece of coded data, wherein the piece of coded data corresponds to a piece of training data referenced by the incorrect answer;
Step (B): correcting the piece of training data into a piece of updated training data that corresponds to the piece of coded data;
Step (C): inputting training data that include the piece of updated training data and the piece of coded data to the AI model to obtain an updated artificial intelligence (AI) model; and
Step (D): testing the updated AI model to determine whether the updated AI model passes an enhanced scoring process.

7. The artificial intelligence correcting method for identifying incorrect training data according to claim 6, wherein a decoding process is performed on the piece of coding data to obtain tag data and the piece of training data is queried based on the tag data.

8. The artificial intelligence correcting method for identifying incorrect training data according to claim 7, wherein the decoding process is a Base64 decoding process.

9. The artificial intelligence correcting method for identifying incorrect training data according to claim 6, wherein in the enhanced scoring process, a plurality of questions are provided to test the updated AI model, and the plurality of questions are associated with the piece of training data referenced by the incorrect data.

10. The artificial intelligence correcting method for identifying incorrect training data according to claim 6, wherein in the enhanced scoring process, a plurality of keywords are provided based on the piece of training data referenced by the incorrect answer, and the plurality of keywords are configured to design the plurality of questions associated with the incorrect answer.
